(19) United States
(12) Patent Application Publication
(10) Pub. No.: US 2023/0351076 A1
(43) Pub. Date: Nov. 2, 2023

(54) CLASSIFICATION AND SIMILARITY DETECTION OF MULTI-DIMENSIONAL OBJECTS

(71) Applicant: Accenture Global Solutions Limited, Dublin (IE)

(72) Inventor: Dylan James Snow, Concord, CA (US)

(21) Appl. No.: 18/309,375

(22) Filed: Apr. 28, 2023

Related U.S. Application Data
(60) Provisional application No. 63/336,515, filed on Apr. 29, 2022.

(51) Int. Cl. G06F 30/27

(52) U.S. Cl. CPC G06F 30/27; G06F 2111/02

(57) ABSTRACT

Implementations are directed to converting a product representation stored in a computer-readable file to a mesh representation, the product representation including a multi-dimensional model of an object, generating a graph representation from the mesh representation, the graph representation including a set of vertices, each vertex associated with a set of coordinates in multi-dimensional space, providing a compound vector representation as a data structure including a set of vectors, each vector in the set of vectors including an m-bit vector that encodes a respective vertex of the set of vertices, the m-bit vector including a set of bit groups, each bit group representing a respective coordinate associated in the set of coordinates of the respective vertex, and processing the compound vector representation through a ML system to generate a prediction associated with the object.

### CROSS-REFERENCE TO RELATED APPLICATIONS

This application claims the benefit under 35 U.S.C. § 119(e) of U.S. Patent Application No. 63/336,515, entitled “Improved Classification and Similarity Detection of Multi-Dimensional Objects,” filed Apr. 29, 2022, which is incorporated herein by reference in its entirety.

### BACKGROUND

Enterprises continuously strive to improve product manufacturing processes, but face numerous hurdles. Many problems arise in the domain of product lifecycle management from the design, testing, and release of a product, through sunsetting of the product. For example, effort and cost for introducing a new part (e.g., a product, a component of a product) extend far beyond the design stage. Some enterprises, such as airline manufacturers, can have hundreds of thousands to millions of different parts (e.g., millions of parts per plane) across their hundreds to thousands of factories and employees across the globe. In some cases, a significant fraction of the parts maintained in electronic systems can be for products (e.g., planes) that are no longer in production.

In many instances, introducing a new part is not as simple as spending a short period of time in a computer-aided design (CAD) program and quickly moving to milling, grinding, drilling, and/or casting the part. Instead, introducing a new part often requires a significant expenditure of time, resources, and money to go from initial design to deployment in production, when taking into consideration logistics, supply chain, purchasing, inventory and testing, among other considerations. Further, demands are increasingly personalized. For example, one-in-five consumers express an interest in personalized products. Research suggests that such consumers are willing to pay a 20% premium, 42% would also rather be led by manufacturers than design something themselves, and 65% are willing to share more personal data for a better, more customer-focused experience. In addition, the product development lifecycle is often too siloed. For example, research suggests that 63% of executives feel that their current product lifecycle is too long for what consumers in the marketplace are demanding. As another example, it takes 6 weeks on average to identify root cause issues for product defects.

### SUMMARY

Implementations of the present disclosure are generally directed to computer-implemented systems for improved classification and similarity detection of multi-dimensional objects using machine learning (ML). More particularly, implementations of the present disclosure are directed to generating a compound vector representation of a multi-dimensional object represented in an object file (e.g., a computer-aided design (CAD) file) and using the compound vector representation for classification and/or similarity detection.

In some implementations, actions include converting a product representation stored in a computer-readable file to a mesh representation, the product representation including a multi-dimensional model of an object, generating a graph representation from the mesh representation, the graph representation including a set of vertices, each vertex associated with a set of coordinates in multi-dimensional space, providing a compound vector representation as a data structure including a set of vectors, each vector in the set of vectors including an m-bit vector that encodes a respective vertex of the set of vertices, the m-bit vector including a set of bit groups, each bit group representing a respective coordinate associated in the set of coordinates of the respective vertex, and processing the compound vector representation through a ML system to generate a prediction associated with the object. Other implementations of this aspect include corresponding systems, apparatus, and computer programs, configured to perform the actions of the methods, encoded on computer storage devices.

These and other implementations can each optionally include one or more of the following features: providing a compound vector representation as a data structure includes, for each vertex, normalizing each coordinate to a normalization range to provide normalized coordinates, binning and discretizing normalized coordinates to adjusted values, and mapping adjusted values to indices of a respective vector; normalizing is based on a maximum value of a coordinate within sets of coordinates across all vertices in the set of vertices; each bit group has a single bit set equal to a first value and all other bits set equal to a second value; the prediction includes classifying the object to at least one category in a set of categories; the prediction includes predicting a similarity between the object and at least one other object; the product representation includes a boundary representation (BRep); and the mesh representation includes a triangular mesh representation.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 depicts an example system that can execute implementations of the present disclosure.

FIG. 2 depicts an example network representation of an example three-dimensional (3D) object.

FIG. 3 depicts an example of generation of a vector representing a vertex of a graph representation of a product in accordance with implementations of the present disclosure.

FIG. 4 depicts an example machine learning (ML)-based system for object classification in accordance with implementations of the present disclosure.

FIG. 5 depicts an example use case of ML-based systems in accordance with implementations of the present disclosure.

FIG. 6 depicts an example process that can be executed in accordance with implementations of the present disclosure.

Like reference symbols in the various drawings indicate like elements.

### DETAILED DESCRIPTION

Implementations of the present disclosure are generally directed to computer-implemented systems for improved classification and similarity detection of multi-dimensional objects using machine learning (ML). More particularly, implementations of the present disclosure are directed to generating a compound vector representation of a multi-dimensional object represented in an object file (e.g., a computer-aided design (CAD) file) and using the compound vector representation for classification and similarity detection. As described in further detail herein, implementations of the present disclosure provide time- and resource-efficiencies and improved accuracy in ML-based classification and similarity detection of multi-dimensional objects.

In some implementations, actions include converting a product representation stored in a computer-readable file to a mesh representation, the product representation including a multi-dimensional model of an object, generating a graph representation from the mesh representation, the graph representation including a set of vertices, each vertex associated with a set of coordinates in multi-dimensional space, providing a compound vector representation as a data structure including a set of vectors, each vector in the set of vectors including an m-bit vector that encodes a respective vertex of the set of vertices, the m-bit vector including a set of bit groups, each bit group representing a respective coordinate associated in the set of coordinates of the respective vertex, and processing the compound vector representation through a ML system to generate a prediction associated with the object.

To provide context for implementations of the present disclosure, CAD is used across multiple industries for the design and manufacture of products. Generally, CAD programs boost the productivity of designers, reduces lead times in the concept-to-manufacture pipeline, and increases the overall quality of products. CAD programs enable designers to use computers to create, modify, analyze, and optimize product designs. Some CAD programs enable virtual testing of product designs prior to physical prototyping and/or manufacturing. The product design is stored in a computer-readable file (CAD file), which can be used in subsequent phases of the design process. For example, the CAD file can be read by a three-dimensional (3D) printer, which can print a physical copy of the product.

An issue that arises in use of CAD, is the multitude of product designs that are generated, in some cases, for the same product. Traditional CAD programs are either absent functionality or provide limited functionality for reuse of previous product designs. For example, in many cases, product designers may be unaware of previous product designs, or even if aware, be unable to find the CAD files recording the previous product designs. That is, for example, hundreds to thousands of CAD files could be provided, which would take longer to search through than to recreate the product in CAD. As a result, product designers quite frequently re-design products from scratch. This results in increasing the already significant number of CAD files that need to be stored and maintained, which burdens technical resources (e.g., processors, memory). This also results in complications in industries that are regulated. For example, and without limitation, aircraft parts and/or surgical equipment can require regulatory approval for use, which can be an onerous process. Situations frequently arise, in which CAD files for product designs that have already received regulatory approval are not available to a product designer, requiring the product designer to find another solution (e.g., re-design the product from scratch) extending the product design process and expending technical resources.

In view of the foregoing, and other considerations, implementations of the present disclosure provide improved classification and similarity detection of multi-dimensional objects using ML. More particularly, implementations of the present disclosure are directed to generating a combined vector representation of a multi-dimensional object represented in an object file (e.g., a CAD file) and using the combined vector representation for classification and/or similarity detection.

Implementations of the present disclosure are described in further detail herein with reference to CAD, boundary representation, and object types, among other terms. In general, CAD includes CAD programs that enable users (e.g., product designers) to define data objects that represent a product (also referred to herein as a product design). For example, and without limitation, a CAD program enables users to incrementally add operations and constraints to construct a product within the CAD program. Example operations include, without limitation, drawing lines, circles, squares, extrusions, and the like. Example constraints include, without limitation, perpendicular, parallel, coincident, and the like. Example CAD programs include, without limitation, AutoCAD, SketchUp, Rhino, and FreeCAD. In some examples, a boundary representation (BRep) can be described as a geometric and topological description of the boundary of an object, the boundary being segmented into a finite number of bounded faces, each face being represented by its bounding edges and vertices. In some examples, a BRep can be provided as a network of boundary components.

In some examples, a product can be internally represented within a CAD program as a sequence of operations (e.g., circle, arc, line) and constraints (e.g., perpendicular, coincident, parallel) that are progressively recorded in an object representation. In some examples, the object representation is provided as a sketch graph (or sketchgraph) that is executed by a solver to produce visualizations of the product (e.g., 3D images, 2D images) displayed by the CAD program. In some examples, the object representation is provided as a BRep that is executed by a solver to produce visualizations of the product (e.g., 3D images, 2D images) displayed by the CAD program. In some examples, the object representation (sketch graph, BRep) is described in computer-readable code that defines, among other things, components, properties of components, relationships between components, properties of relationships, and boundaries. For example, components can be represented as nodes (also referred to as vertices) and relationships can be represented as edges between nodes.

Example object types can include, without limitation, 2D, 2.5D, and 3D. In some examples, 2D refers to a 2D image (e.g., a screenshot of a 3D model, referred to as a render). In some examples, 2.5D refers to a set 2D images (e.g., a set of screenshots of a 3D model), each 2D image being from different angle. The set of 2D images collectively represent a ‘pseudo-3D’ representation of a product, capturing some sense of the depth of the product in 3D.

In some examples, 3D refers to a 3D model. Example types of 3D models can include a voxel model, a point cloud model, and a mesh model. In some examples, a voxel model represents a product as a set of regular sized cubes placed within a 3D grid (e.g., representing the product in a Minecraft-style). In general, a point cloud model can be described as a multi-dimensional point representation of an object that includes a set of n points defined by a coordinate system. In some examples, each point is represented by coordinates (e.g., [x,y,z]). In some examples, additional dimensions can be added to the representation of each point by, for example, determining normals, local features (e.g., color channels (RGB)), and/or global features. In general, a mesh model can be described as a multi-dimensional mesh representation of an object that includes a mesh of interconnected polygons (e.g., triangles), each shape representing a face of the object. More particularly, a mesh model is represented as mesh data that includes sets of vertices, edges, and faces, where vertices are connected with edges and closed sets of edges form faces. In some examples, the faces are polygons, such as triangles. Implementations of the present disclosure are described in further detail herein with non-limiting reference to triangles. In some examples, the mesh model includes a set of n faces, and each face is defined as a set of initial values. In some examples, the set of initial values includes face information and neighbor information. Examples of face information include center (e.g., coordinates [x,y,z] of the center point), corner (e.g., vectors from the center point to each vertex), and normal (e.g., unit normal vector). Example neighbor information includes neighbor index (e.g., indexes of connected faces).

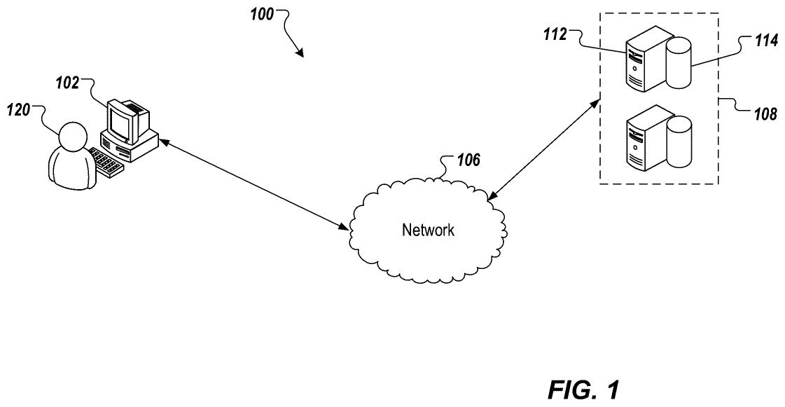

FIG. 1 depicts an example system 100 that can execute implementations of the present disclosure. The example system 100 includes a computing device 102, a back-end system 108, and a network 106. In some examples, the network 106 includes a local area network (LAN), wide area network (WAN), the Internet, or a combination thereof, and connects web sites, devices (e.g., the computing device 102), and back-end systems (e.g., the back-end system 108). In some examples, the network 106 can be accessed over a wired and/or a wireless communications link.

In some examples, the computing device 102 can include any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In the depicted example, the back-end system 108 includes at least one server system 112 and data store 114 (e.g., database).

In some examples, the computing device 102 can execute a CAD program. In some examples, the at least one server system 112 hosts a CAD program that enables a user 120 to create or edit a product design recorded in a CAD file. For example, the user 120 can interact with the CAD program over the network 106 using the computing device. In some examples, the CAD program can be provided as a web-based application, in which user interfaces (Uls) are displayed by a web browser application executed on the computing device 102. The CAD program enables a user 120 to create or edit a product design recorded in a CAD file. In some examples, the CAD program includes or operates with one or more of a ML-based classification system and a ML-based similarity system.

As described in further detail herein, implementations of the present disclosure can process an object representation of a product to provide a compound vector representation. The compound vector representation can be processed by a ML-based classification system to classify the product to one or more categories in a set of categories. In some examples, a neural network can be used to predict a class that a particular product belongs to. For example, the neural network processes the compound vector representation and outputs a set of categories that the product is predicted to belong to (e.g., process a product representation of a desk and outputs a set of categories including desk, table, bench, chair, each class having a score indicating a probability of the product belonging to the respective class).

The compound vector representation can be processed by a ML-based similarity system to identify one or more products that the product can be determined to be similar to. In some examples, a neural network can be used to predict a similarity between the product and one or more other products. For example, the neural network processes the compound vector representation of the product and a compound vector representation of another product, and outputs a similarity score. The similarity score represents a degree of similarity between the product and the other product. In some examples, the similarity score can be compared to a threshold similarity score and the product and the other product can be determined to be similar (or the same) if the similarity score exceeds the threshold similarity score.

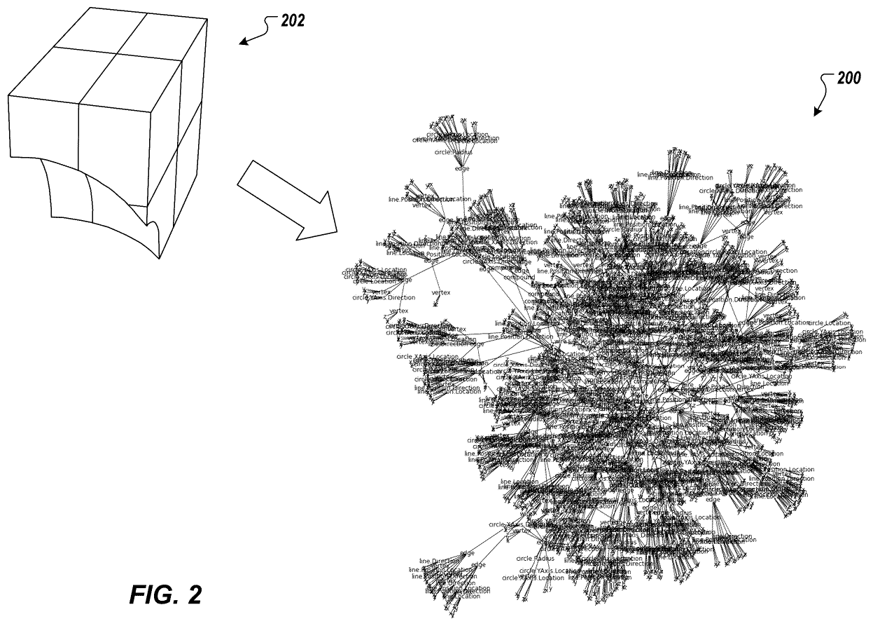

FIG. 2 depicts an example network representation 200 of an example three-dimensional (3D) object 202. In some examples, the network representation 200 is provided from a boundary representation (BRep) of the object 202, which is recorded in a CAD file (e.g., .step file). It is contemplated, however, that the network representation 200 can be provided as any appropriate network representation of the 3D object 202 and is not limited to BRep. In some examples, the network representation 200 represents boundaries of characteristics of boundaries of a product. For example, nodes of the network representation 200 represent boundaries and/or boundaries of objects and edges represent relationships between nodes. In general, constituent components recorded in a CAD file include vertices, edges, wires, faces, shells, solids, and compounds. In general, boundary representations are more mathematically precise than other representations, such as triangular meshes. For example, a parabolic curve that represents one curve within a BRep file is always more precise than a quantized set of points and edges that approximate that curve in a mesh file. As discussed herein, a product representation can be provided and can include a boundary representation among other possible representations (e.g., point cloud, mesh).

Product representations, such as a boundary representation, can be processed for ML-based classification and/or similarity detection. However, while boundary representations are highly precise in representing a product, resulting accuracy of ML-based systems can suffer when processing boundary representations. For example, providing a boundary representation as input to a wireframe-only, graph-based 3D object classification ML model has been seen to not achieve an accuracy beyond 50%. That is, the object classification is incorrect more often than correct. While accuracy improvements might be achievable by adding shells, compounds, and solids to the boundary representation input to the ML-model, this would require a more complex ML model and larger data files. Both have an undesirable follow-on effect of increased consumption of technical resources (e.g., processors, memory) to effect classification and/or similarity detection.

In view of the above context, implementations of the present disclosure provide an improved approach to classification and similarity detection. For example, and as described in further detail herein, implementations of the present disclosure provide a compound vector representation of a product. In some examples, the compound vector representation is provided as a set of vectors, each vector representing a vertex of a graph representation of the product. For example, the graph representation can include p vertices. Consequently, the compound vector representation (CVR) is provides as a set of vectors V=[v₁, . . . vₚ]. The graph representation is provided from a mesh representation, which is provided from a boundary representation (BRep). In some examples, each vector is n-bit in length (e.g., n=256), and includes binary values representing respective axis values of the vertex. For example, of the n-bits, only 3-bits represent the x-axis, the y-axis, and the z-axis respectively. In some examples, for each vector, 3-bits are set equal to 1, while all other bits are set equal to 0. In this manner, the compound vector representation provides a relatively sparse (in terms of data footprint) representation of a product. By way of non-limiting example, if p=2000 (i.e., 2000 vertices in the graph representation) and n=256 bits, the compound vector representation is 512 kb. In general, the CVR is considerably smaller in terms of memory than storing a full triangular mesh, for example (e.g., as a .obj, .stl, or .fbx file).

The compound vector representation can be processed through a ML-based classification system and/or ML-based similarity determination system to classify the object represented by the compound vector representation and identify other products that may be similar to the object represented by the compound vector representation, respectively. Implementations of the present disclosure have been seen to provide an accuracy of up to 92% in classification across a set of object categories. In view of the relative sparsity of the compound vector representation, less complex ML models can be employed in the ML-based systems and technical resources are conserved as compared to other approaches (e.g., classification using a full BRep).

As described in further detail, a product representation is received, for example, in the form of an object file of a CAD program (e.g., .obj, .step). In some examples, the product representation is provided as a BRep, as described herein. In some examples, the product representation is converted to a mesh representation (e.g., a triangular mesh) and the mesh representation is converted to a graph representation. In some examples, the graph representation includes a set of vertices (nodes) and edges between vertices. Each vertex is associated with coordinates in 3D space (i.e., x, y, z coordinates). A vector is generated for each vertex in the set of vertices and a compound vector representation is provided as a set of vectors that includes the vectors representing the vertices. The compound vector representation is provided as input to a ML-based system for classification and/or similarity detection, as described herein.

In further detail, the product representation is converted to a mesh representation using any appropriate conversion program. For example, CAD systems can provide built-in conversion tools to convert from a boundary representation to a mesh representation. In some implementations, the mesh representation includes a triangular mesh, which can be described as a collection of points in 3D space and the edges between the points that group into faces. For a triangular mesh, each face has three sides, forming a triangle (3-gon). It is appreciated that implementations of the present disclosure are not limited to triangular meshes and can be realized with any appropriate number of edges (m-gon) for a more general case of polygonal meshes. As noted above, converting from the boundary representation to a mesh representation results in a less-precise representation of the product. That is, the mesh representation is less precise that the boundary representation.

In some implementations, the mesh representation is processed to provide a so-called clean mesh representation. For example, the mesh representation is processed to extract a point cloud, remove outliers, and simplify the mesh to a threshold number of vertices (e.g., 2000 vertices, p=2000). The mesh representation is re-triangulated (for a triangular mesh) and faces are generated to ensure that the clean mesh representation is watertight. In some examples, the mesh representation is processed using a mesh processing program to provide the clean mesh representation. An example mesh processing program includes Trimesh (trimsh.org), which can be described as a Python library for loading and using triangular meshes with an emphasis on watertight surfaces to provide a full-featured and well-tested Trimesh object (i.e., the clean mesh representation of the present disclosure).

In some implementations, the clean mesh representation is converted to a network graph representation. For example, the clean mesh representation is processed using a network graphing program to provide the network graph representation. An example network graphing program includes NetworkX (network.org), which provides data structures and methods for generating and storing graphs. NetworkX can be described as a library for creating and visualizing graphs. In some examples, a NetworkX graph is provided from the clean mesh representation by iterating through every vertex and creating a NetworkX node, and iterating through every edge and creating a NetworkX edge to connect the nodes of that edge in the NetworkX graph. For each vertex, the X, Y, Z position of the vertex is determined, normalized, and combined into a CVR. In some implementations, a network graphing program, such as NetworkX, can be foregone and the clean mesh representation can be converted directly a network graph representation.

In some examples, the coordinates of each vertex are normalized. For example, and as described in further detail below by way of example, the coordinate having the highest value in 3D space is determined and all other coordinates are normalized to that value. In some examples, the highest value is normalized to 1 and all other coordinates are normalized based on 1. In this manner, each vertex is associated with normalized coordinates. In some examples, for each vertex, each normalized coordinate is mapped to an index position. For example, a fixed length vector (e.g., 256-bit vector) is used to represent each vertex, and bits of the vector are grouped based on the number of coordinates. For example, for 3 coordinates (x, y, z), the vector is divided into three groups of consecutive bits (bit groups). In the case of a 256-bit vector, for example, a first bit group [0-85] corresponds to the x-coordinate, a second bit group [86-170] corresponds to the y-coordinate, and a third bit group [171-255] corresponds to the z-coordinate. That is, each coordinate value is mapped to an index position within a respective bit group. In this manner, each vertex is represented as a vector having three bits equal to 1 and all other bits equal to 0. This can be referred to as tri-hot encoding of each vertex in a vector.

In some implementations, the network graph representation is converted to a graph representation that is appropriate for processing through a graph neural network (GNN) library. An example GNN library includes the Deep Graph Library (www.dgl.ai), which can be described as a Python open source library that enables building, train, and evaluating GNNs on datasets.

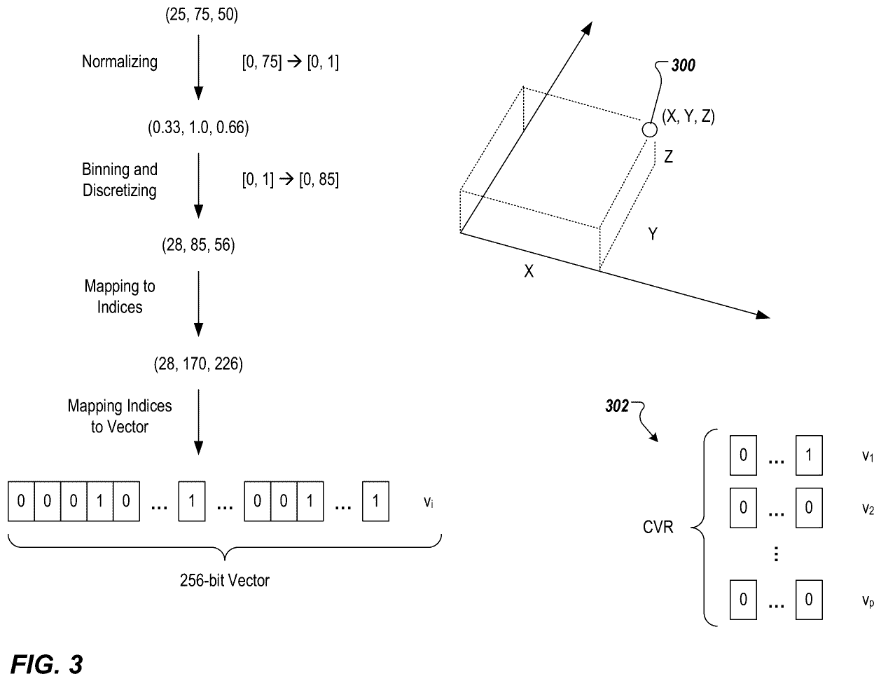

FIG. 3 depicts an example of generation of a vector representing a vertex of a graph representation of a product in accordance with implementations of the present disclosure. In the example of FIG. 3, a vertex 300 is depicted and is associated with x, y, z coordinates in 3D space. In the example of FIG. 3, the vertex 300 is a vertex of a network graph that represents a product (e.g., a network graph output by a graphing program, such as NetworkX).

In the example of FIG. 3, it can be determined that a coordinate associated with the has the highest value among coordinates of all vertices. For example, the vertex 300 is associated with coordinates (25, 75, 50), where the y-coordinate is determined to have the highest value, here, 75. Consequently, the coordinates are normalized to a range of [0, 1], where 75 is normalized to 1. In the example of FIG. 3, each coordinate is normalized to the range of [0, 1], such that the coordinates (25, 75, 50) are normalized to provide normalized coordinates of (0.33, 1.0, 0.66).

In the example of FIG. 3, binning and discretizing is executed. In some examples, binning and discretizing transforms a continuous number into a discrete number that is suitable for discrete mathematical operations. Discretizing and binning one single continuous number, for example 0.66, which is normalized to be inside the range [0-1], to a discrete number of bins, N=85, involves multiplying the normalized single continuous number by the number of bins and then rounding it. For example, 0.66=0.66*85=56.1 56, therefore 0.66 binned and discretized is 56.

In the example of FIG. 3, the discretized coordinates are mapped to indices. In some examples, discretized coordinates can be mapped to different indices of a 1-D array in a similar fashion to the flattening of 2-D or N-D images in computer vision that are flattened into 1-D tensors for the purposes of machine learning. In mapping to indices, the continuous normalized coordinates in the (X, Y, Z) tuple of (0.33, 1.0, 0.66), for example, are binned and discretized to become (28, 85, 56) when the number of bins N=85. These discretized coordinates can then be mapped or flattened by mapping their values to a flat tensor of length N*3=85*3=255. In this case, the flattening of the discretized coordinates (28, 85, 56) leads to mapped values of (28+0*N, 85+1*N, 56+2*N)=(28+0*85, 85+1*85, 56+2*85)=(28, 170, 226).

It is appreciated that the example of FIG. 3 represents a single vertex of hundreds to thousands of vertices in a network graph (e.g., 2000 vertices). Accordingly, the process represented in FIG. 3 is performed for each vertex to provide a set of vectors that make up a compound vector representation (CVR) 302 of the product.

As introduced above, the product is represented as a compound vector representation that includes a set of vectors (p vectors), each vector representing a respective vertex as, for example, a 256-bit vector. Accordingly, the compound vector representation can itself be described as a graph representation, because it encodes vertices of the underlying network graph (e.g., output from the network graphing program).

In some implementations, a ML-based classification system includes a GNN that processes the compound vector representation to classify the product to a set of categories. An example GNN can be provided as a Graph Isomorphism Network (GIN), which can be described as a GNN that is able to approximate the Weisfeiler-Lehman graph isomorphism test, which is used to determine similarity between graphs. In graph isomorphism, two graphs are considered isomorphic, if there is a mapping between the vertices of the graphs that preserves vertex adjacencies. In graph isomorphism, two graphs are considered isomorphic, if there is a mapping between the nodes of the graphs that preserves node adjacencies. In some implementations, the GNN is trained using training data. Example training data includes the Princeton ModelNet 40 and ModelNet 10 object category benchmarks.

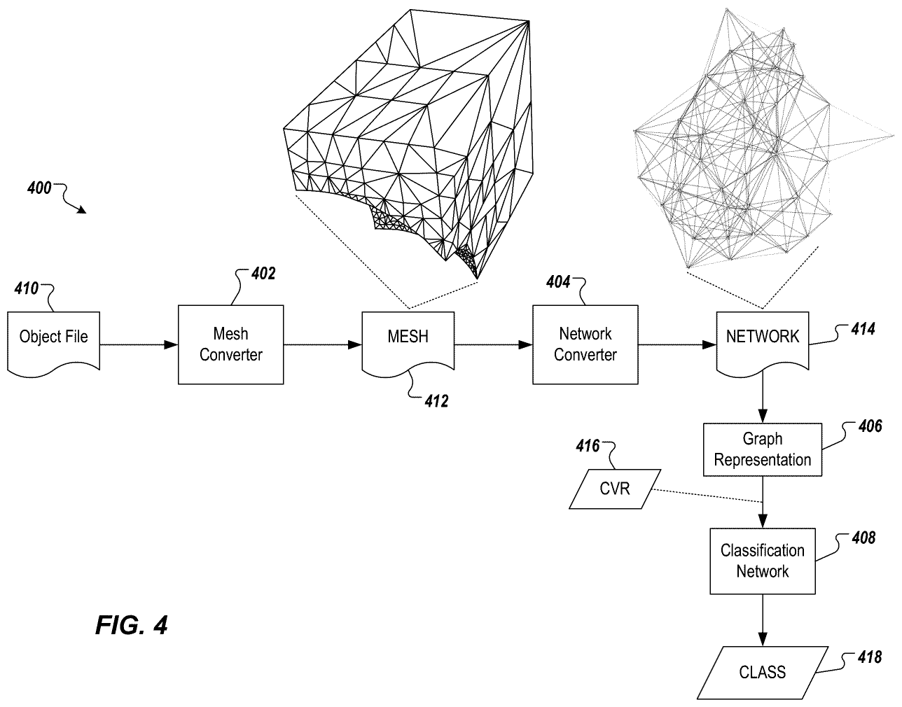

FIG. 4 depicts an example machine learning ML-based system 400 for object classification in accordance with implementations of the present disclosure. In the example of FIG. 4, the example ML-based system 400 includes a mesh converter 402, a network converter 404, a graph representation module 406, and a classification network 408.

The mesh converter 402 receives an object file 410 that provides a product representation (e.g., a boundary representation) of a product. In some examples, the object file 410 is provided from a CAD program. In some examples, the mesh converter 402 is included in the CAD program. The mesh converter 402 processes the product representation stored in the object file 402 to provide a mesh representation 412 (e.g., a triangular mesh representation). Although not depicted in FIG. 4, in some examples, the mesh representation 412 is processed by a mesh processing program (e.g., Trimesh) to provide a clean mesh representation.

The mesh representation 412 (or clean mesh representation) is processed by the network converter 404 to provide a network graph representation 414. For example, the network converter 404 executes a graphing program, such as NetworkX, to provide the network graph representation 414. In some examples, the network graph representation 414 is process by the graph representation module 406 to provide a compound vector representation (CVR) 416. As described herein, the CVR 416 can itself be described as a graph representation, because it encodes vertices of the underlying network graph (e.g., output from the network graphing program).

The CVR 416 is provided as input to the classification network 408, which processes the CVR 416 to provide a class prediction 418. In some examples, the classification network 408 includes a GIN that processes the CVR 416 to provide the class prediction 418. In some examples, the class prediction 418 indicates a single category that the product is predicted to belong to with a confidence score that represents a confidence with which the product belongs to the category. In some examples, the class prediction 418 includes a set of categories that the product can be potentially classified to. In some examples, each category is associated with a confidence score that represents a confidence with which the product belongs to the respective category.

As introduced above, the compound vector representation of the present disclosure can be used to determine whether a product is similar to one or more other products. For example, a neural network (e.g., a GIN) can be used to predict a similarity between the product and one or more other products. For example, the neural network processes the compound vector representation of the product and a compound vector representation of another product, and outputs a similarity score. The similarity score represents a degree of similarity between the product and the other product. In some examples, the similarity score can be compared to a threshold similarity score and the product and the other product can be determined to be similar (or the same) if the similarity score exceeds the threshold similarity score.

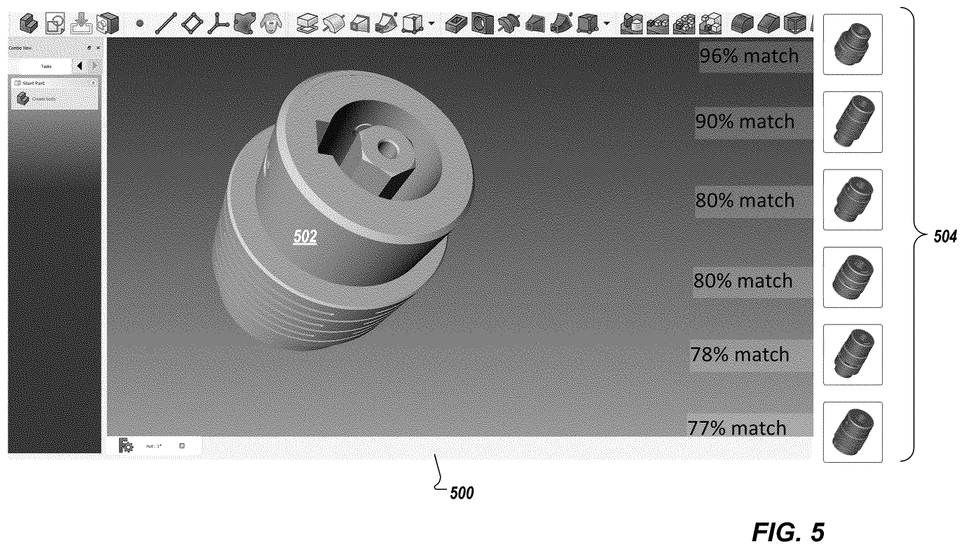

FIG. 5 depicts an example use case in accordance with implementations of the present disclosure. In some implementations, the search assistant reviews a product representation during a progression of a current product design, provides a product representation of the product design at respective instances of the progression, and identifies, based on the product representation, one or more previous product designs to recommend to the product designer. That is, as the product progresses, a product representation is provided, which can be used to identify one or more previous product designs that the product is progressing toward.

With particular reference to FIG. 5, a UI 500 displays a visualization 502 of a product. For example, the product can be designed by a user, the user progressively designing the product using the CAD program. In some implementations, a search assistant processes a product representation to provide a set of search results 504. In some examples, the set of search results includes one or more stored products that have a level of similarity to the product in a current state of design. In this sense, a stored product can be considered an existing product design that is stored in a library of product designs. In some examples, a stored product includes a product that had been previously designed and is stored in a CAD file that is accessible to the CAD program. In some examples, each stored product in the set of stored products 504 is associated with a degree of similarity representing a level of similarity between the product and a respective stored product. In some examples, the user can select a stored product from the set of stored products 504.

For example, an object file of the product of the visualization 502 can be processed as described herein to provide a compound vector representation of the product. The compound vector representation can be processed through a ML-based classification system to determine a category of the product. In some examples, a set of compound vector representations can be retrieved from computer-readable memory and can be associated with the category. For example, each compound vector representation in the set of compound vector representations is representative of an existing product that is in the category. A neural network (e.g., a GIN) processes the compound vector representation of the product and compound vector representations of each of the existing products in the category, and outputs similarity scores. In some examples, existing products having a similarity score that exceeds a threshold similarity score can be displayed to the user (e.g., as the set of search results 504).

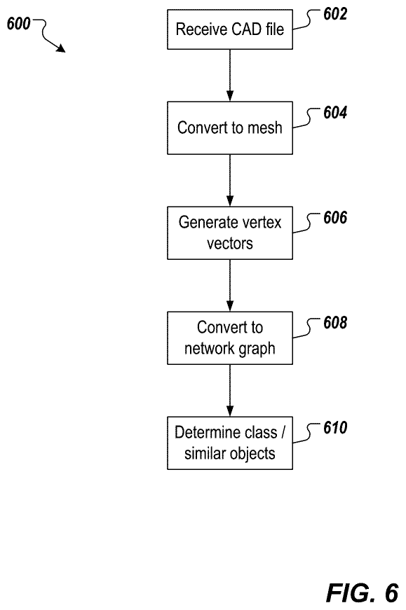

FIG. 6 depicts an example process 600 that can be executed in accordance with implementations of the present disclosure. In some examples, the example process 600 is provided using one or more computer-executable programs executed by one or more computing devices.

A CAD file is received (602). For example, and as described herein with reference to FIG. 4, the mesh converter 402 receives an object file 410 that provides a product representation (e.g., a boundary representation) of a product. The product representation is converted to a mesh representation (604). For example, and as described herein, the mesh converter 402 processes the product representation stored in the object file 402 to provide a mesh representation 412 (e.g., a triangular mesh representation). Although not depicted in FIG. 4, in some examples, the mesh representation 412 is processed by a mesh processing program (e.g., Trimesh) to provide a clean mesh representation. A vertex vector is generated for each vertex (606). For example, and as described herein, the network graph representation 414 is process by the graph representation module 406 to provide a compound vector representation (CVR) 416. For example, for each vertex, a vector is generated that provides a tri-hot encoded representation of the vertex. The vertex vectors are provided in a set of vectors that constitute the compound vector representation. The (clean) mesh representation is converted to a network graph (608). For example, and as described herein, the mesh representation 412 (or clean mesh representation) is processed by the network converter 404 to provide a network graph representation 414. For example, the network converter 404 executes a graphing program, such as NetworkX, to provide the network graph representation 414. A class and/or similar objects are determined (610). For example, and as described herein, the CVR 416 is provided as input to the classification network 408, which processes the CVR 416 to provide a class prediction 418. In some examples, a neural network (e.g., a GIN) can be used to predict a similarity between the product and one or more other products. For example, the neural network processes the compound vector representation of the product and a compound vector representation of another product, and outputs a similarity score.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code) that constitutes processor firmware, a protocol stack, a database management system, an operating system, or a combination of one or more of them. A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display), LED (light-emitting diode) monitor, for displaying information to the user and a keyboard and a pointing device (e.g., a mouse or a trackball), by which the user may provide input to the computer. Other kinds of devices may be used to provide for interaction with a user as well; for example, feedback provided to the user may be any appropriate form of sensory feedback (e.g., visual feedback, auditory feedback, or tactile feedback); and input from the user may be received in any appropriate form, including acoustic, speech, or tactile input.

Implementations may be realized in a computing system that includes a back end component (e.g., as a data server), or that includes a middleware component (e.g., an application server), or that includes a front end component (e.g., a client computer having a graphical user interface or a Web browser through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”) (e.g., the Internet).

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the to be filed claims.

What is claimed is:

1. A computer-implemented method for time- and resource-efficient processing of multi-dimensional models of products through machine learning (ML) systems, the method comprising:
converting a product representation stored in a computer-readable file to a mesh representation, the product representation comprising a multi-dimensional model of an object;
generating a graph representation from the mesh representation, the graph representation comprising a set of vertices, each vertex associated with a set of coordinates in multi-dimensional space;
providing a compound vector representation as a data structure comprising a set of vectors, each vector in the set of vectors comprising an m-bit vector that encodes a respective vertex of the set of vertices, the m-bit vector comprising a set of bit groups, each bit group representing a respective coordinate associated in the set of coordinates of the respective vertex; and
processing the compound vector representation through a ML system to generate a prediction associated with the object.

2. The method of claim 1, wherein providing a compound vector representation as a data structure comprises, for each vertex:
normalizing each coordinate to a normalization range to provide normalized coordinates;
binning and discretizing normalized coordinates to adjusted values; and
mapping adjusted values to indices of a respective vector.

3. The method of claim 1, wherein normalizing is based on a maximum value of a coordinate within sets of coordinates across all vertices in the set of vertices.

4. The method of claim 1, wherein each bit group has a single bit set equal to a first value and all other bits set equal to a second value.

5. The method of claim 1, wherein the prediction comprises classifying the object to at least one category in a set of categories.

6. The method of claim 1, wherein the prediction comprises predicting a similarity between the object and at least one other object.

7. The method of claim 1, wherein the product representation comprises a boundary representation (BRep).

8. The method of claim 1, wherein the mesh representation comprises a triangular mesh representation.

9. A non-transitory computer-readable storage medium coupled to one or more processors and having instructions stored thereon which, when executed by the one or more processors, cause the one or more processors to perform operations for time- and resource-efficient processing of multi-dimensional models of products through machine learning (ML) systems, the operations comprising:
converting a product representation stored in a computer-readable file to a mesh representation, the product representation comprising a multi-dimensional model of an object;
generating a graph representation from the mesh representation, the graph representation comprising a set of vertices, each vertex associated with a set of coordinates in multi-dimensional space;
providing a compound vector representation as a data structure comprising a set of vectors, each vector in the set of vectors comprising an m-bit vector that encodes a respective vertex of the set of vertices, the m-bit vector comprising a set of bit groups, each bit group representing a respective coordinate associated in the set of coordinates of the respective vertex; and
processing the compound vector representation through a ML system to generate a prediction associated with the object.

10. The non-transitory computer-readable storage medium of claim 9, wherein providing a compound vector representation as a data structure comprises, for each vertex:
normalizing each coordinate to a normalization range to provide normalized coordinates;
binning and discretizing normalized coordinates to adjusted values; and
mapping adjusted values to indices of a respective vector.

11. The non-transitory computer-readable storage medium of claim 9, wherein normalizing is based on a maximum value of a coordinate within sets of coordinates across all vertices in the set of vertices.

12. The non-transitory computer-readable storage medium of claim 9, wherein each bit group has a single bit set equal to a first value and all other bits set equal to a second value.

13. The non-transitory computer-readable storage medium of claim 9, wherein the prediction comprises classifying the object to at least one category in a set of categories.

14. The non-transitory computer-readable storage medium of claim 9, wherein the prediction comprises predicting a similarity between the object and at least one other object.

15. The non-transitory computer-readable storage medium of claim 9, wherein the product representation comprises a boundary representation (BRep).

16. The non-transitory computer-readable storage medium of claim 9, wherein the mesh representation comprises a triangular mesh representation.

17. A system, comprising:
a computing device; and
a computer-readable storage device coupled to the computing device and having instructions stored thereon which, when executed by the computing device, cause the computing device to perform operations for time- and resource-efficient processing of multi-dimensional models of products through machine learning (ML) systems, the operations comprising:
converting a product representation stored in a computer-readable file to a mesh representation, the product representation comprising a multi-dimensional model of an object;
generating a graph representation from the mesh representation, the graph representation comprising a set of vertices, each vertex associated with a set of coordinates in multi-dimensional space;
providing a compound vector representation as a data structure comprising a set of vectors, each vector in the set of vectors comprising an m-bit vector that encodes a respective vertex of the set of vertices, the m-bit vector comprising a set of bit groups, each bit group representing a respective coordinate associated in the set of coordinates of the respective vertex; and
processing the compound vector representation through a ML system to generate a prediction associated with the object.

18. The system of claim 17, wherein providing a compound vector representation as a data structure comprises, for each vertex:
normalizing each coordinate to a normalization range to provide normalized coordinates;
binning and discretizing normalized coordinates to adjusted values; and
mapping adjusted values to indices of a respective vector.

19. The system of claim 17, wherein normalizing is based on a maximum value of a coordinate within sets of coordinates across all vertices in the set of vertices.

20. The system of claim 17, wherein each bit group has a single bit set equal to a first value and all other bits set equal to a second value.

21. The system of claim 17, wherein the prediction comprises classifying the object to at least one category in a set of categories.

22. The system of claim 17, wherein the prediction comprises predicting a similarity between the object and at least one other object.

23. The system of claim 17, wherein the product representation comprises a boundary representation (BRep).

24. The system of claim 17, wherein the mesh representation comprises a triangular mesh representation.
